(19) United States
(12) Patent Application Publication
(10) Pub. No.: US 2012/0157897 A1
(43) Pub. Date: Jun. 21, 2012

(54) MASSAGE MACHINE

(75) Inventors: Minoru Kawamoto, Shiga-ken (JP); Noboru Nishuguchi, Shiga-ken (JP); Hiroyuki Inoue, Shiga-ken (JP); Takeshi Izunaka, Osaka (JP)

(73) Assignee: Panasonic Electric Works Co., Ltd., Osaka (JP)

(21) Appl. No.: 13/393,385

(22) PCT Filed: Sep. 2, 2010
(86) PCT No.: PCT/JP2010/065009

§ 371 Date: Feb. 29, 2012

(30) Foreign Application Priority Data
Sep. 25, 2009 (JP) 2009-220465

(51) Int. Cl. A61H 9/00

(52) U.S. Cl. 601/148

(57) ABSTRACT

A massage device (10) includes a seat (12), a backrest (13), and an ottoman (14). The ottoman (14) includes a leg rest (14a) and a foot rest (14)b on one side, and a leg placing portion (14c), on which legs of a user can be placed, on the other side. Also, the ottoman (14) is supported to be rotational by a support shaft (16a) provided on a pair of support frames (16) of the seat (12) to extend in the lateral direction. By rotating the ottoman (14), the ottoman (14) is shifted between a massage capable state, in which recesses (14a, 14b) are exposed to the front of the seat (12), and a leg placing state, in which the leg placing portion (14c) is exposed to the front of the seat (12). The leg rest (14a) of the ottoman 14 includes airbags. The foot rest (14b) is supported to be slidable with respect to the leg rest (14a).

### TECHNICAL FIELD

The present invention relates to a massage device capable of massaging the legs of a user.

### BACKGROUND ART

Conventionally, a massage device has been proposed that includes a tiltable ottoman in front of a seat on which a user can be seated. The ottoman includes an airbag that is selectively inflated and deflated to massage the legs of a user (for example, see Patent Document 1).

Also, the ottoman provided in the massage device of Patent Document 1 includes a leg rest that has a pair of recesses into which the legs of the user can be inserted independently as shown in FIG. 3 of the publication. Airbags are included in side walls of each recess. In a state where the legs are inserted in the recesses, the airbags are inflated and deflated so that the legs (particularly, the calves) of the user are separately massaged.

In addition to the leg rest, massage devices have been developed that include a foot rest having recesses capable of supporting the feet of a user from the soles. The foot rest is provided separately from the leg rest. In such massage devices, to accommodate the height of individual users (in particular, the length below knees), massage devices have been developed in which the leg rest and the foot rest are slidable in an integral manner with respect to the seat. Therefore, the ottoman, which includes the leg rest and the foot rest, is slid in accordance with the length of the legs, which differs depending on the individual user to adjust the position of the leg rest and the foot rest. As a result, the legs of the user can be put on the ottoman at a position according to preference.

### PRIOR ART DOCUMENT

### Patent Document

Patent Document 1: Japanese Patent No. 3508771

### SUMMARY OF THE INVENTION

### Problems that the Invention is to Solve

In the above-mentioned massage devices, the length of the legs differs depending on the individual user who uses the massage device. For example, the longer the legs of the user, the greater the difference in the distance between the soles to knees or soles to calves. In other words, for example, if the foot rest and the leg rest on the ottoman are designed for users with short legs, the position of the leg rest is closer to the soles than the calves for users with long legs. Therefore, it is difficult to massage the calves of the user by the massage means provided on the leg rest in a suitable manner. As such, the position of the entire ottoman can be adjusted and used at a position of the individual preference by forming the leg rest and the foot rest to be integrally slidable with respect to the seat. However, since the leg rest is also moved integrally, it is difficult to massage the preferred position of the legs of the user with the massage means provided on the leg rest. Therefore, there is a need for improvement.

Also, since the ottoman includes recesses of the leg rest and the recesses of the foot rest, the recesses may become obstructions when the user sits on the seat. In addition, in the aspect of improving aesthetic quality of the entire massage device, it is desirable that the recesses be stored.

Accordingly, it is an objective of the present invention to provide a massage device that is capable of storing a leg rest and a foot rest and of massaging legs of a user in a suitable manner in accordance with the size of the user.

### Means for Solving the Problems

In accordance with one aspect of the present invention, a massage device is provided. The massage device includes a seat on which a user can be seated, an ottoman located in front of the seat and on which legs of the user can be placed, and leg massage means provided on the ottoman. The leg massage means massages the legs of the user. The ottoman includes, on a first side, a leg rest having recesses in which the legs of the user can be inserted and a foot rest having recesses that supports feet of the user from soles. The leg massage means are provided in the recesses of the leg rest, and the ottoman includes, on a second side, a leg placing portion on which the legs of the user can be placed. The ottoman is rotationally supported by a support shaft, which extends in a lateral direction with respect to a pair of support portions provided on the seat. By rotating the ottoman, the ottoman is switched between a massage capable state, in which the recesses are exposed to the front of the seat, and a leg placing state, in which the leg placing portion is exposed to the front of the seat. The foot rest is supported to be slidable relative to the leg rest.

The foot rest is preferably supported to be rotational with respect to the leg placing portion, and the foot rest preferably includes urging means that urges the distal end portion of the foot rest, which distal end portion is on the front side in the massage capable state, toward the support shaft by a predetermined urging force.

The foot rest is preferably supported to be rotational with respect to the leg placing portion, and the foot rest is preferably selectively arranged at a stored position where the angle defined by a bottom surface of the recesses of the foot rest and a bottom surface of the recesses of the leg rest is an acute angle.

The leg massage means preferably includes an airbag that is selectively inflated and deflated.

The recesses of the foot rest preferably include foot massage means for massaging the feet of the user.

The foot massage means preferably includes an airbag that is selectively inflated and deflated.

### BRIEF DESCRIPTION OF THE DRAWINGS

FIG. 1 is a schematic side view illustrating a massage device according to one embodiment of the present invention;

FIG. 2 is a side view illustrating the massage device of FIG. 1 in a state where the foot rest of the ottoman is extended;

FIG. 3 is a side view illustrating the massage device of FIG. 1 in which the ottoman is in a leg placing state;

FIG. 4 is a front view illustrating the ottoman;

FIG. 5 is a side view illustrating the ottoman; and

FIG. 6 is a side view illustrating a slide mechanism of an ottoman according to a modified embodiment.

### MODES FOR CARRYING OUT THE INVENTION

A massage device according to one embodiment of the present invention will now be described with reference to the drawings.

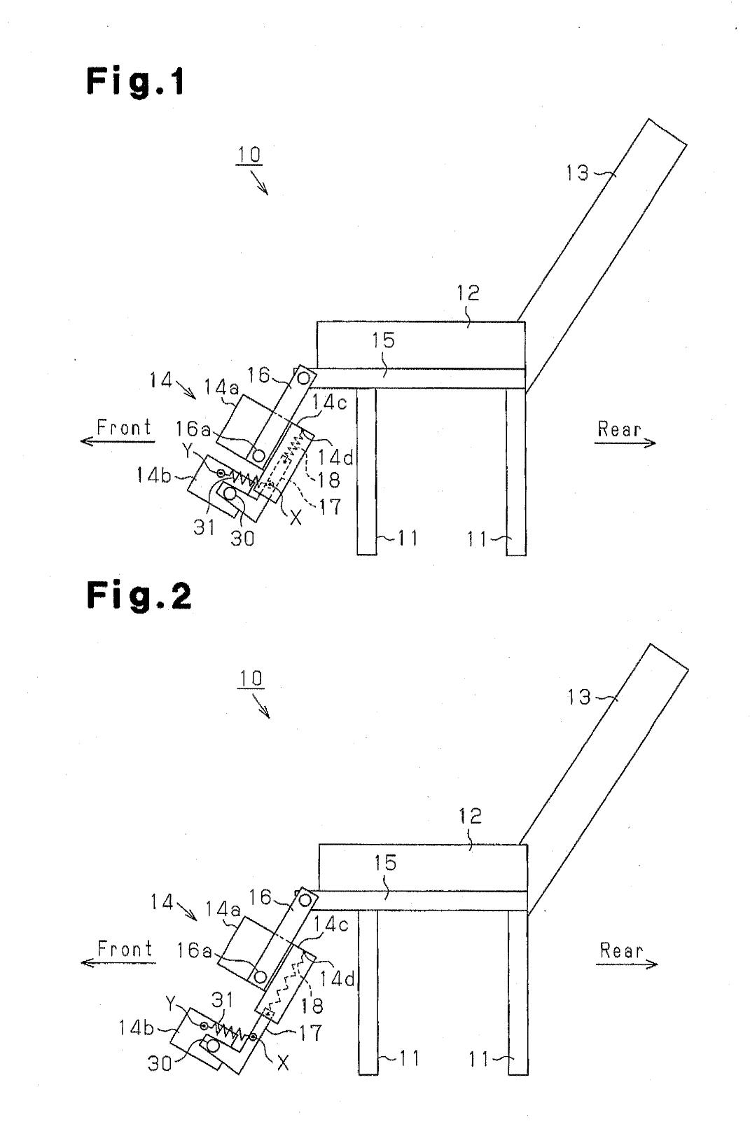

FIG. 1 is a schematic side view illustrating a massage device of the present embodiment. The massage device 10 includes legs 11, a seat 12, a backrest 13, and an ottoman 14. The legs 11 are located on a floor surface, which is not shown. The seat 12 on which a user can be seated is provided on the legs 11.

The backrest 13 is provided on the rear part of the seat 12 to be tiltable with respect to the seat 12. The ottoman 14 is provided on the front part of the seat 12 to be tiltable with respect to the seat 12. Also, a pair of frames 15 (only one is shown in FIG. 1) is provided on the seat 12 to extend between the rear part and the front part of the seat 12. The proximal ends of support frames 16 are connected to the front ends of the frames 15. The support frames 16 extend in the vertical direction. The ottoman 14 is rotationally mounted on the distal ends of the support frames 16 with a support shaft 16a, which extends in the lateral direction of the seat 12 (the direction perpendicular to the sheet of FIG. 1).

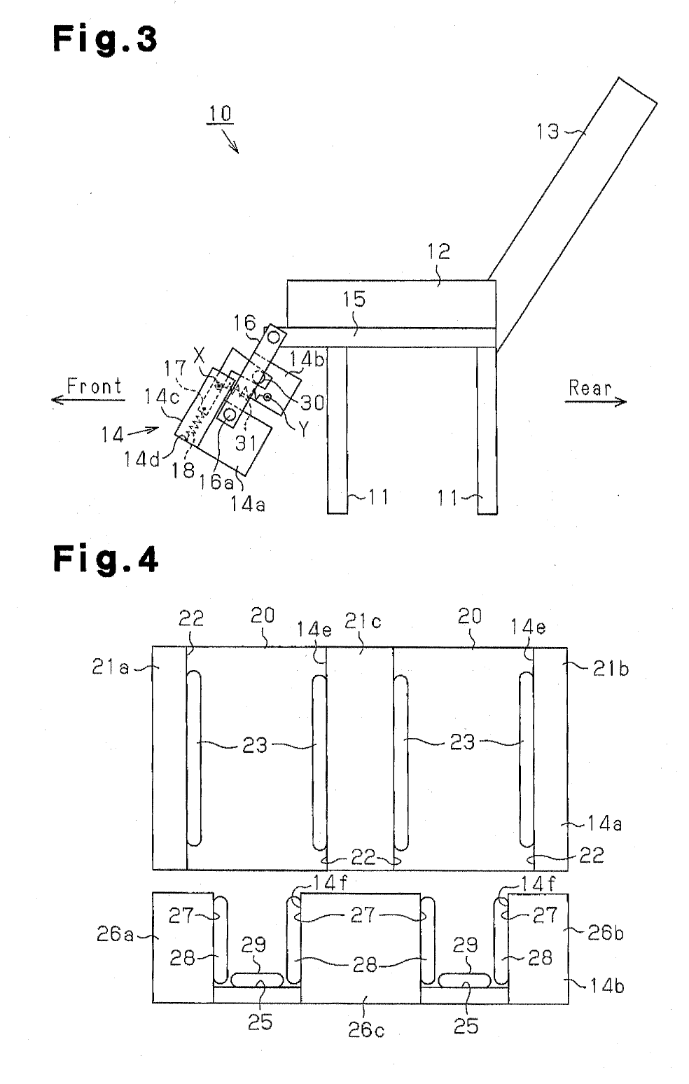

The ottoman 14 includes a leg rest 14a and a foot rest 14b. The leg rest 14a is connected to the distal ends of the support frames 16, and includes a pair of recesses 14e into which legs (calves) of a user seated in the seat 12 can be inserted. The foot rest 14b includes a pair of recesses 14f on which the feet of the user are placed and supported. Also, on the other side of the ottoman 14 from the leg rest 14a and the foot rest 14b, a substantially planar leg placing portion 14c on which the legs of the user can be placed is fixed to the leg rest 14a. Therefore, in the massage device 10 of the present embodiment, by rotating the ottoman 14 about the support shaft 16a, the ottoman 14 can be shifted between a massage capable state (see FIG. 1) and a leg placing state (see FIG. 3). In the massage capable state, airbags 23, 28, 29 (see FIG. 4), which serve as massage means and are provided in the recesses 14e, 14f, are exposed on the front surface of the massage device 10. Accordingly, it becomes possible to massage the user. In the leg placing state, the leg placing portion 14c is exposed on the front surface of the massage device 10. Thus, the user's legs can be placed on the leg placing portion 14c.

The leg rest 14a includes three side walls 21a to 21c, which extend in substantially the same direction on both edges and at the center of the leg rest 14a as shown in FIG. 4. Each recess 14e is defined by a bottom portion 20 and a pair of inner surfaces 22 of the side walls 21a to 21c. The airbag 23, which serves as leg massage means, is provided on each inner surface 22.

The foot rest 14b is supported on the leg placing portion 14c by a pair of L-shaped support frames 17 and a pair of springs 18. The leg placing portion 14c has a predetermined space therein. The proximal ends of the support frames 17 supporting the foot rest 14b are inserted in the space. The proximal end of each support frame 17 is urged toward the downstream end 14d in the insertion direction inside the leg placing portion 14c by the associated spring 18. Thus, when the user applies a certain force on a bottom surface 25 (see FIG. 4) of the foot rest 14b by the legs (feet) in the extending direction (upstream in the insertion direction) against the springs 18, the foot rest 14b is slid with respect to the leg rest 14a into an extended state as shown in FIG. 2. Also, when the force against the springs 18 is not applied to the foot rest 14b, the springs 18 urge the support frames 17 toward the downstream end in the insertion direction, and the foot rest 14b is maintained in the normal state shown in FIG. 1.

The foot rest 14b provided at the distal end of the support frames 17 includes three side walls 26a to 26c, which extend in substantially the same direction on both edges and at the center of the foot rest 14b as shown in FIG. 4. Each recess 14f is defined by the bottom portion 25 and a pair of inner surfaces 27 of the side walls 26a to 26c. The airbag 28, which serves as foot massage means, is provided on each inner surface 27. Furthermore, the airbag 29, which serves as sole massage means, is provided on the bottom surface 25 of each recess 14b. The pair of airbags 28 provided on the pair of inner surfaces 27 of the foot rest 14b are arranged at a position closer to the center between the corresponding pair of inner surfaces 22, 27 as compared to the pair of airbags 23 provided on the pair of inner surfaces 22 of the leg rest 14a.

The foot rest 14b is supported to be rotational with respect to the leg rest 14a about a support shaft 30. An urging member 31 such as a spring is provided on both sides of the foot rest 14b. The distal end portion of the foot rest 14b (left side in FIG. 1) is constantly urged toward the leg rest 14a (the support shaft 16a) by the urging members 31. More specifically, one end of each urging member 31 is fixed to a fixing point X on the side surface of the support frame 17. The fixing point X is located higher (position closer to the seat 12) than the fixing point Y at the distal end portion (left side in FIG. 1) of the foot rest 14b. Therefore, the distal end portion of the foot rest 14b is urged toward the leg rest 14a about the support shaft 30. Accordingly, the size of the ottoman 14 as a whole is reduced, and the ottoman 14 is easily rotated. As described above, the pair of airbags 28 is arranged at a position closer to the center between the corresponding pair of inner surfaces 22, 27 as compared to the pair of airbags 23. Thus, the airbags 23 and the airbags 28 are displaced in the lateral direction. When the foot rest 14b is rotated to a stored position, the airbags 23 and the airbags 28 are prevented from interfering with each other. Also, the foot rest 14b is more reliably rotated to the desired position, which is the stored position.

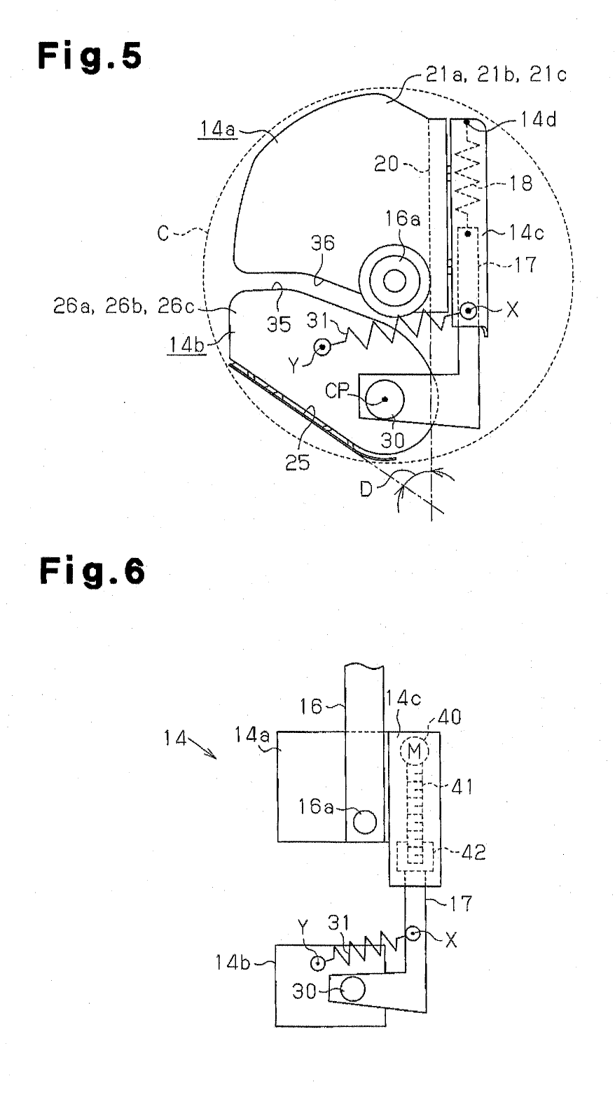

In particular, as shown in FIG. 5, in a state where the foot rest 14b is urged by the urging members 31 toward the leg rest 14a, end surfaces 35 of the side walls 26a to 26c of the foot rest 14b face end surfaces 36 of the side walls 21a to 21c of the leg rest 14a. The end surfaces 35, 36 are formed such that the distances between each end surface 35 and the corresponding end surface 36 are substantially equal. Therefore, the size of the entire ottoman 14 is reduced, which permits the ottoman 14 to be rotated in a suitable manner. At this time, the foot rest 14b is urged by the urging members 31 to the position where the rotating angle D between the bottom surface 25 of the foot rest 14b and the bottom surface 20 of the leg rest 14a is substantially 55 degrees such that the foot rest 14b is stored in an imaginary circle C having a predetermined radius. The imaginary circle C has, for example, a radius that is half the distance from the floor surface (not shown) to the lower surface of the seat 12. Accordingly, while the size of the ottoman 14 is maximized, the floor surface and the lower surface of the seat 12 and the ottoman 14 are prevented from interfering each other when rotating the ottoman 14.

If the force toward the leg rest 14a is greater than the urging force of the urging members 31, the distal end portion of the foot rest 14b is rotated in the direction opposite to the leg rest 14a about the support shaft 30. As shown in FIG. 5, when a straight line (not shown) connecting the fixing points X, Y of the urging member 31 exceeds the center point CP of the support shaft 30, the urging member 31 urges the foot rest 14b in the direction opposite to the leg rest 14a. Accordingly, the foot rest 14b is arranged in an extended position. In the extended position, the foot rest 14b is fixed such that the bottom surface 20 of the leg rest 14a is substantially parallel to the bottom surface 25 of the foot rest 14b. Therefore, for example, the massage device accommodates with users with long legs. Furthermore, the airbags 23, 28 of the leg rest 14a and the foot rest 14b can massage from the legs to the ankles of the user.

In the ottoman 14 of the massage device 10 formed as described above, a non-illustrated air pump is controlled so that the airbags 23, 28, 29 inflate and deflate as required in response to supply and exhaust of air through the air pump. Accordingly, the legs and the feet of the user are massaged. Furthermore, according to the massage device 10 of the present embodiment, the airbags 23, 28, 29, which serve as the massage means in this embodiment, are provided on one side of the ottoman 14, and the planar leg placing portion 14c is provided on the other side. The ottoman 14 is formed to be rotational. Therefore, the user can select whether to use the ottoman 14 as massage equipment, or as the leg placing portion 14c depending on the user's mood.

When massaging, the height of the foot rest 14b can be adjusted. For example, the user who is seated on the seat 12 presses the bottom surface 25 of the foot rest 14b with the feet (soles) in a direction against the direction in which the springs 18 exert urging force. Accordingly, the foot rest 14b slides with respect to the leg rest 14a. The foot rest 14b can be stopped at the position where the leg rest 14a faces the calves of the user. Therefore, the legs (calves) of the user are massaged in a suitable manner by the airbags 23 provided on the leg rest 14a.

The ottoman 14 also allows the foot rest 14b to be arranged at the stored position. As shown in FIG. 5, the foot rest 14b can be retained at the stored position where the rotating angle between the bottom surface 20 of the leg rest 14a and the bottom surface 25 of the foot rest 14b is an acute angle, which is substantially 55 degrees. In this manner, since the foot rest 14b is rotated to the position closer to the leg rest 14a compared to the conventional massage device (ottoman), the size of the ottoman 14 is reduced. Thus, the ottoman 14 is easily rotated.

Also, the foot rest 14b is formed to be rotational and is shifted to the state in use where the rotating angle D (FIG. 5) is a right angle as in the conventional massage device. This prevents reduction in the effects of massage by the airbags 28 associated with reduction in the size of the ottoman 14.

The present embodiment has the following advantages.

(1) The ottoman 14 includes the leg rest 14a and the foot rest 14b on one side, and the leg placing portion 14c, on which the legs of the user can be placed, on the other side. Also, the ottoman 14 is rotationally supported by the support shaft 16a provided on the support frames 16 of the seat 12 to extend in the lateral direction. By rotating the ottoman 14, the ottoman 14 is selectively switched between the massage capable state, in which the recesses 14e, 14f are exposed to the front of the seat 12, and the leg placing state, in which the leg placing portion 14c is exposed to the front of the seat 12. In this manner, the ottoman 14 is selectively switched between the massage capable state in which the recesses 14e and the recesses 14f are exposed and the leg placing state in which the recesses 14a, 14b are stored and the leg placing portion 14c on the other side is exposed. Thus, the recesses 14a, 14b are not exposed in the leg placing state, and the user can be seated easily. Also, since the ottoman 14 can be switched between the massage capable state and the leg placing state, the user can select the massage capable state or the leg placing state depending on the user's mood. This improves the convenience of the ottoman 14. Also, the leg rest 14a of the ottoman 14 includes the airbags 23, which serve as the massage means, and the foot rest 14b is slidable with respect to the leg rest 14a. Therefore, the entire length of the ottoman 14 can be changed in accordance with the length of the legs of the user. By stopping the foot rest 14b at a desired position, the leg rest 14a is indirectly adjusted to a position where the legs (calves) of the user can be massaged. Thus, the legs (calves) of the user can be massaged by the airbags 23 in a suitable manner.

(2) The foot rest 14b includes the urging members 31, which urge the distal end portion of the foot rest 14b that is at the front side in the massage capable state toward the support shaft 16a by a predetermined urging force. Thus, the size of the ottoman 14 as a whole is reduced by urging the distal end portion of the rotational foot rest 14b toward the support shaft 16a by the predetermined urging force with the urging members 31. In the present configuration, in which the ottoman 14 is rotated, the ottoman 14 can be easily rotated by reducing the size of the ottoman 14. The airbags 29, which serve as the massage means, are provided on the bottom surfaces 25 of the foot rest 14b, which support the feet of the user from the soles. In the case where the airbags 29 are inflated, if force acts on the rotational foot rest 14b in the direction opposite to the direction in which the user's soles are pressed, it is difficult to massage in a suitable manner. At this time, since the foot rest 14b is urged toward the support shaft 16a by the urging members 31 in the present configuration, the opposite force as described above is reduced, and it is possible to massage in a suitable manner.

(3) The foot rest 14b is formed to be rotational. Also, the foot rest 14b is formed to be selectively maintained at the stored position where the rotating angle D between the bottom surface 25 of the foot rest 14b and the bottom surface 20 of the leg rest 14a is an acute angle. Thus, the foot rest 14b is rotated with respect to the leg rest 14a to a position where the rotating angle D formed by the bottom surfaces 20, becomes an acute angle, that is, to a position closer to the leg rest 14a as compared to the conventional massage device (ottoman). This reduces the size of the ottoman as a whole. Also, since the foot rest 14b is rotational, the foot rest 14b can be shifted to the position in use where the rotating angle D is substantially a right angle. Therefore, the present embodiment in which the airbags 28 are provided on the foot rest 14b can be operated in the same manner as the conventional massage device, and prevents the reduction in the effect of massage associated with the reduction in the size of the ottoman 14.

(4) Since the foot rest 14b includes the airbags 28, which serve as the foot massage means for massaging the feet of the user, the feet of the user are massaged.

(5) The massage means is formed by the airbags 23, 28, 29, which selectively inflate and deflate. Thus, the user can be softly massaged.

The embodiment of the present invention may be modified as follows.

In the present embodiment, the support frames 17, which support the foot rest 14b, are slidably inserted in the leg placing portion 14c. One end of each support frame 17 is urged toward the downstream end in the insertion direction by the associated spring 18. The structure for supporting the foot rest 14b to selectively extend and contract may be modified. For example, a motor 40, a screw 41, and a nut 42 may be used instead of the springs 18 as shown in FIG. 6. The motor 40 is provided inside the leg placing portion 14c and is rotated. The feed screw 41 is coupled to the motor 40. The nut 42 is threaded to the feed screw 41 and moves linearly by rotating. The feed nut 42 is fixed to the support frame 17. With this structure, the support frame 17 slides by rotating the motor 40 so that the foot rest 14b is moved to a position where the user desires.

In the above embodiment, the foot rest 14b is urged toward the support shaft 16a, which is the center of rotation, by the urging members 31. However, the structure is not limited to this.

In the above embodiment, when the foot rest 14b is in the stored state, the rotating angle D between the bottom surface 25 of the foot rest 14b and the bottom surface 20 of the leg rest 14a is an acute angle (approximately 55 degrees). However, the rotating angle D may be a right angle.

In the above embodiment, the airbags 28, 29 are provided on the foot rest 14b, but the airbags 28, 29 may be omitted.

In the above described embodiment, although not particularly mentioned, for example, a massage mechanism that massages the upper body of the user may be provided in the massage device 10. The massage mechanism includes a treatment element and provided in the backrest 13.

In the above described embodiment, the backrest 13 is tiltable with respect to the seat 12. Instead, the backrest 13 does not need to be tiltable, that is, the backrest 13 may be fixed. Alternatively, the backrest 13 may be omitted.

### DESCRIPTION OF THE REFERENCE NUMERALS

10 . . . Massage Device
11 . . . Legs
12 . . . Seat
14 . . . Ottoman
14a . . . Leg Rest
14b . . . Foot Rest
14c . . . Leg Placing Portion
16 . . . Support Frames (Support Portions)
16a . . . Support Shaft
20, 25 . . . Bottom Surface
23, 28, 29 . . . Airbags (Massage Means)
31 . . . Urging Members (Urging Means)
D . . . Rotating Angle

1. A massage device comprising:
a seat on which a user can be seated
an ottoman located in front of the seat and on which legs of the user can be placed; and
leg massager provided on the ottoman, the leg massager massages the legs of the user, wherein,
the ottoman includes, on a first side, a leg rest having recesses in which the legs of the user can be inserted and a foot rest having recesses that supports feet of the user from soles, the leg massager being provided in the recesses of the leg rest, and the ottoman includes, on a second side, a leg placing portion on which the legs of the user can be placed,
the ottoman is rotationally supported by a support shaft, which extends in a lateral direction with respect to a pair of support portions provided on the seat, wherein, by rotating the ottoman, the ottoman is switched between a massage capable state, in which the recesses are exposed to the front of the seat, and a leg placing state, in which the leg placing portion is exposed to the front of the seat, and
the foot rest is supported to be slidable relative to the leg rest.

2. The massage device according to claim 1, wherein the foot rest is supported to be rotational with respect to the leg placing portion, and the foot rest includes urging member that urges the distal end portion of the foot rest, which distal end portion is on the front side in the massage capable state, toward the support shaft by a predetermined urging force.

3. The massage device according to claim 1, wherein the foot rest is supported to be rotational with respect to the leg placing portion, and the foot rest is selectively arranged at a stored position where the angle defined by a bottom surface of the recesses of the foot rest and a bottom surface of the recesses of the leg rest is an acute angle.

4. The massage device according to claim 1, wherein the leg massager includes an airbag that is selectively inflated and deflated.

5. The massage device according to claim 1, wherein the recesses of the foot rest includes foot massager for massaging the feet of the user.

6. The massage device according to claim 5, wherein the foot massager includes an airbag that is selectively inflated and deflated.
